(19) United States
(12) Patent Application Publication
(10) Pub. No.: US 2006/0227261 A1
(43) Pub. Date: Oct. 12, 2006

(54) Light guide plate and backlight module using the same

(75) Inventor: Wei Shu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/401,195

(22) Filed: Apr. 10, 2006

(30) Foreign Application Priority Data
Apr. 9, 2005 (CN) 200520057011.X

(51) Int. Cl. G02F 1/1335

(52) U.S. Cl. 349/65

(57) ABSTRACT

A light guide plate (20) for use in a backlight assembly includes a base plate (21) and a fastener (210). The base plate includes a light output surface (212), at least two light input surfaces (211) adjacent to the light output surface, and a bottom surface (215) opposite to the at least light output surface. The fastener is integrated with the base plate and is located at a corner of the base plate between the at least two light input surfaces for stably held light sources therein. This helps prevent the light source from being displaced when an LCD device employing the light guide plate is subjected to vibration or shock.

### FIELD OF THE INVENTION

The present invention relates to surface-type illumination devices, and more particularly to a light guide plate and a backlight module installed with a light guide plate, which are typically used in liquid crystal display (LCD) devices.

### BACKGROUND

A typical LCD device includes an LCD panel, and a backlight system mounted under the LCD panel for supplying light beams to the LCD panel. The backlight system mainly includes a light source and a light guide plate. The light guide plate is commonly a transparent acrylic plastic sheet, and is used for guiding light beams emitted by the light source in order to uniformly illuminate the LCD panel.

The light source emits light beams into the light guide plate, and some of the light beams may be totally internally reflected. In order to diffuse the light beams and enable them to emit uniformly from a top surface of the light guide plate, suitable diffusion structures can be employed. For example, protrusions or recesses are located on a bottom surface of the light guide plate, or a plurality of light diffusion dot-patterns are formed on the bottom surface of the light guide plate.

Referring to FIG. 10, a conventional backlight assembly is shown. The backlight assembly 1 includes a light guide plate 11 and a light source 12. The light guide plate 11 is a rectangular sheet. The light guide plate 11 includes a light output surface 112, two generally adjacent light input surfaces 111, and an oblique corner portion 113 between the light input surfaces 111. The light source 12 includes an L-shaped lamp 121, and two rubber endpieces 122 covered over two electrode ends of the lamp 121 respectively. The lamp 121 is disposed around the light input surfaces 111 and the oblique portion 113 of the light guide plate 11, such that illuminating portions (not labeled) of the lamp 121 face the light input surfaces 111 for introducing light beams into the light guide plate 11.

When assembled in an LCD device, the light guide plate 11 and the light source 12 are accommodated and fastened in place by frames (not shown). The position of the light guide plate 11 relative to the lamp 121 of the light source 12 is vulnerable to displacement when the LCD device is subjected to vibration or shock. If the lamp 121 is displaced, this causes loss of some of the light beams emitted therefrom. This in turn diminishes the display characteristics of the LCD device employed the backlight assembly 1.

Accordingly, what is needed is a backlight assembly that can overcome the above-described deficiencies.

### SUMMARY

An exemplary light guide plate includes a base plate and a fastener. The base plate includes a light output surface, at least two light input surfaces adjacent to the light output surface, and a bottom surface opposite to the light output surface. The fastener is integrated with the base plate and is located at a corner of the base plate between the at least two light input surfaces for stably held light sources therein.

An exemplary backlight assembly for a liquid crystal display includes a light source having a lamp, and a light guide plate having a base plate and a fastener. The base plate includes a light output surface, at least two light input surfaces adjacent to the light output surface, and a bottom surface opposite to the light output surface. The fastener is located at a corner of the base plate between the at least two light input surfaces, and the light source is fixed by the fastener.

Other advantages and novel features will become more apparent from the following detailed description when taken in conjunction with the accompanying drawings.

### BRIEF DESCRIPTION OF THE DRAWINGS

FIG. 1 is a schematic, isometric view of a backlight assembly according to a first embodiment of the present invention, the backlight assembly including a light guide plate.

FIG. 2 is an enlarged view of part of the light guide plate of FIG. 1.

FIG. 3 is a schematic, abbreviated bottom view of the light guide plate of FIG. 1, showing a diffusion pattern formed on a bottom surface of the light guide plate.

FIG. 4 is a top view of the backlight assembly of FIG. 1.

FIG. 5 is a schematic, exploded, isometric view of a backlight assembly according to a second embodiment of the present invention.

FIG. 6 is an assembled view of the backlight assembly of FIG. 5.

FIG. 7 is a top view of the backlight assembly shown in FIG. 6.

FIG. 8 is a schematic, top view of a backlight assembly according to a third embodiment of the present invention.

FIG. 9 is a schematic, top view of a backlight assembly according to a fourth embodiment of the present invention.

FIG. 10 is a schematic, top view of a conventional backlight assembly.

### DETAILED DESCRIPTION OF PREFERRED EMBODIMENTS

Reference will now be made to the drawings to describe the present invention in detail.

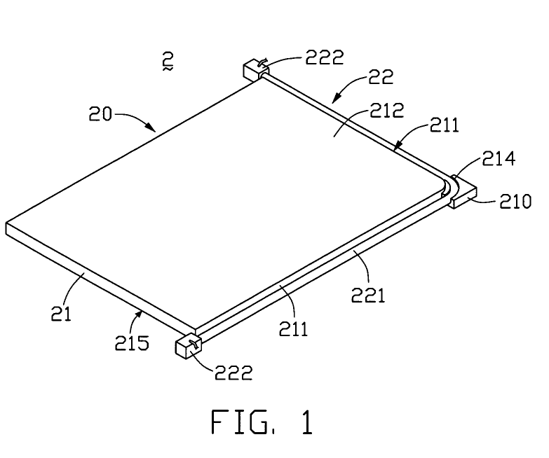

Referring to FIG. 1, a backlight assembly according to a first embodiment of the present invention is shown. The backlight assembly 2 includes a light guide plate 20 and a light source 22.

The light guide plate 20 includes a base plate 21 and a fastener 210. The base plate 21 has a rectangular shape, and includes two generally adjacent light input surfaces 211, a light output surface 212 adjacent to the light input surfaces 211, and a bottom surface 215 opposite to the light output surface 212.

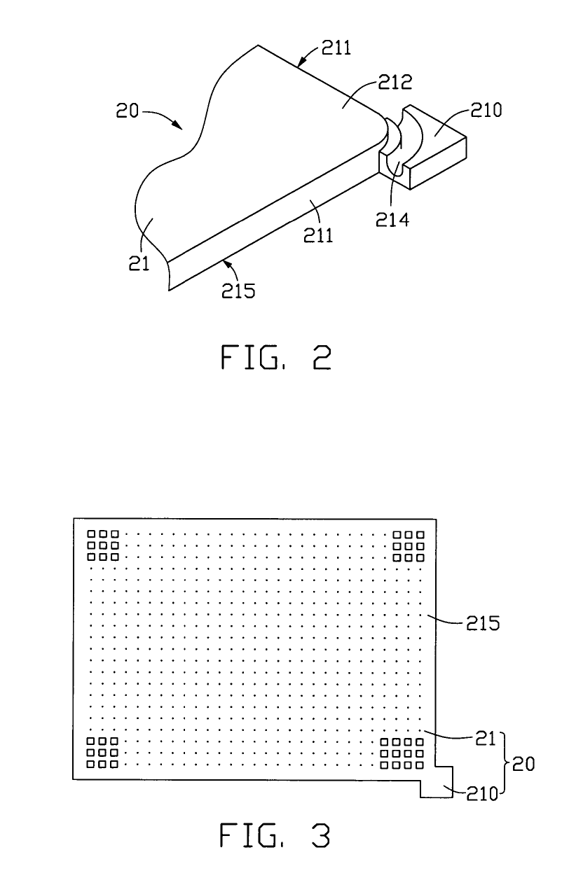

Referring to FIG. 2, an enlarged view of part of the light guide plate 20 is shown. The fastener 210 is integrated with the base plate 21, and is disposed at a corner (not labeled) of the base plate 21 between the two light input surfaces 211. The fastener 210 includes a locating slot 214. The locating slot 214 is arc-shaped, and has a curvature that matches a curvature of the corner.

Referring to FIG. 3, a schematic, bottom view of the light guide plate 20 is shown. The bottom surface 215 of the base plate 21 includes a diffusion pattern (not labeled). In the illustrated embodiment, the diffusion pattern is a multiplicity of square dots. The diffusion pattern causes light beams reaching the bottom surface 215 to evenly emit from the light output surface 212 of the base plate 21.

The light source 22 includes an L-shaped lamp 221 and two rubber endpieces 222 covered the electrode end (not labeled) of the lamp 221. In alternative embodiments, the rubber endpieces 222 can instead be made of another kind of suitable elastic material.

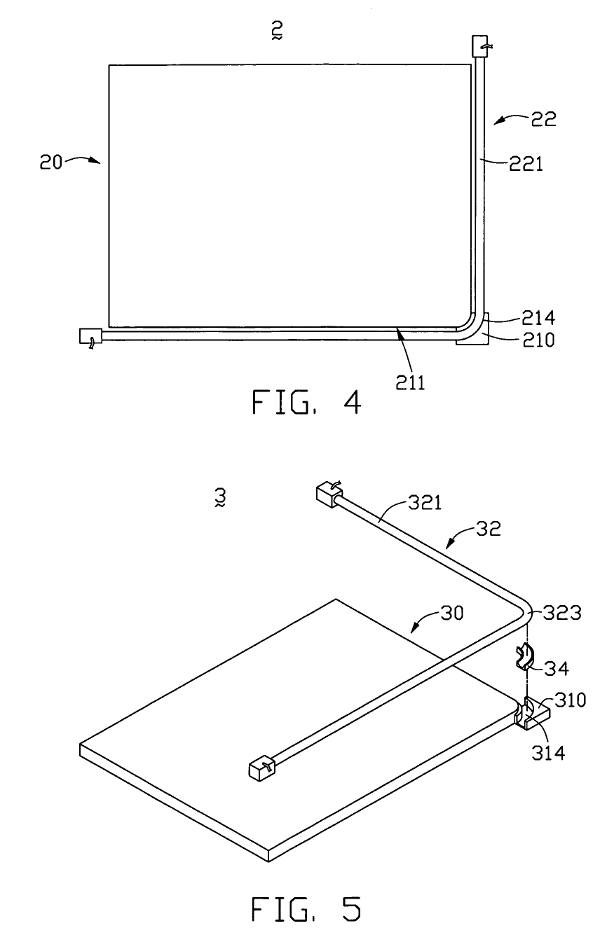

Also referring to FIG. 4, the lamp 221 of the light source 22 is fixed by the fastener 210 and is thus disposed adjacent the two light input surfaces 211 of the base plate 21. In particular, a bent portion (not labeled) of the lamp 221 is fixed in the locating slot 214 of the fastener 210, such that illuminating portions (not labeled) of the lamp 221 face the two light input surfaces 211 for introducing light beams into the base plate 21.

With this configuration, the bent portion of the lamp 221 is fixed in the locating slot 214 of the fastener 210 of the light guide plate 20, and is stably held therein. This helps prevent the lamp 221 from being displaced when an LCD device employing the backlight assembly 2 is subjected to vibration or shock. Moreover, the lamp 221 is located closely adjacent the light input surfaces 211 of the base plate 21. Therefore most if not all of the light beams emitted by the lamp 221 enter the base plate 21, which enables the LCD device to attain high brightness and good display characteristics.

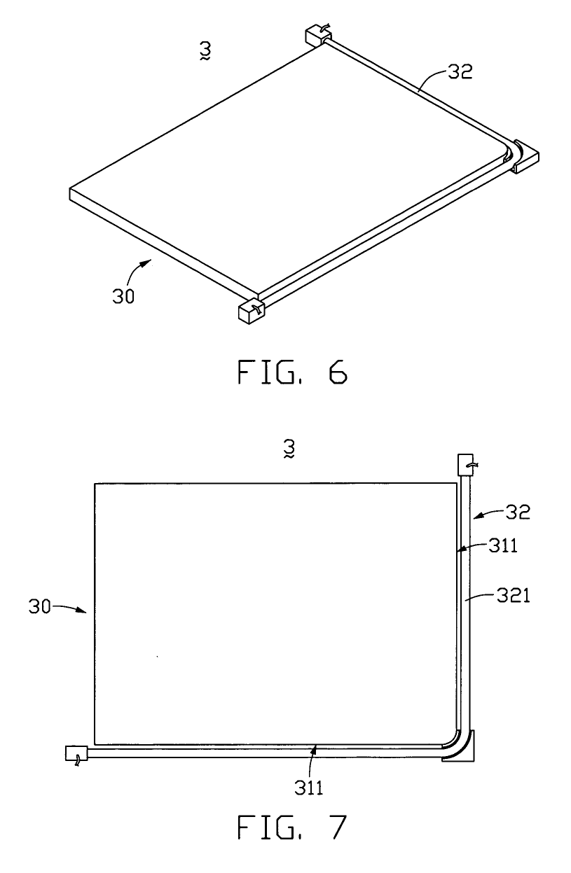

Referring to FIGS. 5-7, a backlight assembly according to a second embodiment of the present invention is shown. The backlight assembly 3 has a structure similar to that of the backlight assembly 2. However, the backlight assembly 3 includes a light guide plate 30, a rubber casing 34, and a light source 32 having an L-shaped lamp 321. The light guide plate 30 includes two generally adjacent light input surfaces 311, and a fastener 310 having a locating slot 314. The rubber casing 34 is made of heat-insulative material, and has a groove (not labeled) defining a semicylindrical profile. In alternative embodiments, the rubber casing 34 can instead be made of another kind of suitable elastic material. In assembly, first, a bent portion 323 of the lamp 321 is fitted into the groove of the rubber casing 34. Then the rubber casing 34 with the lamp 321 attached thereto is fitted into the locating slot 314.

In operation, the rubber casing 34 functions as a buffer, for protecting the lamp 321 from being displaced or damaged when an LCD device employing the backlight assembly 3 is subjected to vibration or shock. Moreover, because the rubber casing 34 is made of heat-insulative material, it helps prevent heat generated by the lamp 321 from directly transmitting into the light guide plate 30.

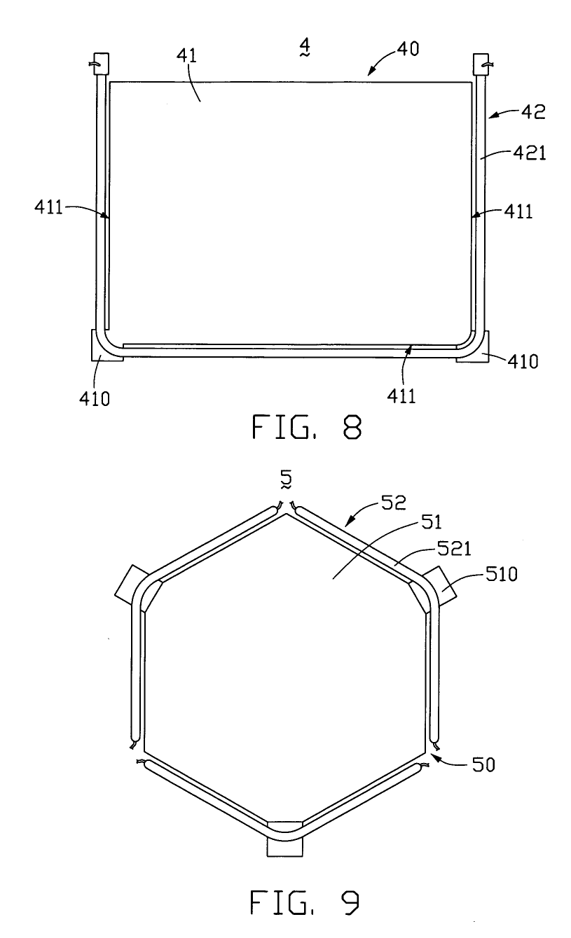

Referring to FIG. 8, this is a schematic, top view of a backlight assembly according to a third embodiment of the present invention. The backlight assembly 4 has a structure similar to that of the backlight assembly 2. However, the backlight assembly 4 includes a light guide plate 40 and a light source 42. The light guide plate 40 includes a base plate 41, and two fasteners 410 disposed at two adjacent comers of the base plate 41. The fasteners 410 are integrated with the base plate 41. The base plate 41 includes three generally adjacent light input surfaces 411. The light source 42 includes a U-shaped lamp 421. Two bent portions (not labeled) of the U-shaped lamp 421 are fixed in the fasteners 410 respectively, such that illuminating portions (not labeled) of the lamp 421 face the three light input surfaces 411 for introducing light beams into the base plate 41.

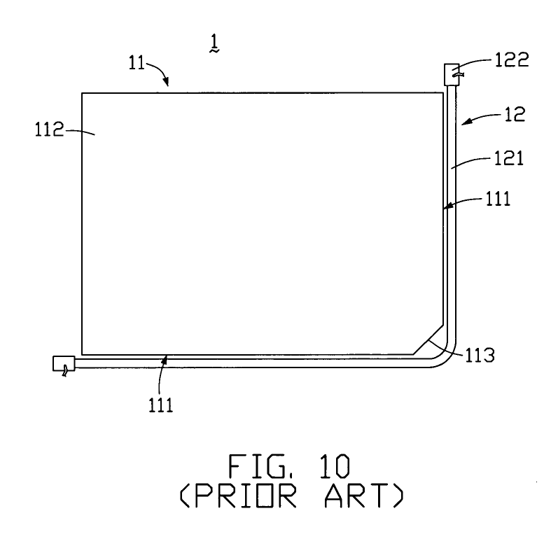

Referring to FIG. 9, this is a schematic, top view of a backlight assembly according to a fourth embodiment of the present invention. The backlight assembly 5 has a structure similar to that of the backlight assembly 2. However, the backlight assembly 5 includes a light guide plate 50 and a light source 52. The light guide plate 50 includes a hexagonal base plate 51, and three fasteners 510 disposed at three non-adjacent corners (not labeled) of the base plate 51 respectively. The light source 52 includes three V-shaped lamps 521, which are fixed by the fasteners 520 respectively.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guide plate for a backlight assembly, comprising:
a base plate comprising a light output surface, at least two light input surfaces adjacent to the light output surface, and a bottom surface opposite to the light output surface; and
at least one fastener located at least one corner of the base plate between the at least two light input surfaces.

2. The light guide plate as claimed in claim 1, wherein the at least one fastener is integrated with the base plate.

3. The light guide plate as claimed in claim 2, wherein the at least one fastener comprises a locating slot having an arc-shaped profile.

4. The light guide plate as claimed in claim 3, wherein the base plate has a rectangular shape, the at least one fastener is two fasteners, and the fasteners are arranged at two adjacent corners of the base plate.

5. The light guide plate as claimed in claim 3, wherein the base plate has a hexagonal shape, the at least one fastener is three fasteners, and the fasteners are arranged at three non-adjacent corners of the base plate.

6. A backlight assembly for a liquid crystal display, comprising:
a light source comprising at least one lamp; and
a light guide plate comprising a base plate and at least one fastener;
wherein the base plate comprises a light output surface, at least two light input surfaces adjacent to the light output surface, and a bottom surface opposite to the light output surface, the at least one fastener is located at at least one corner of the base plate between the at least two light input surfaces, and the light source is fixed by the at least one fastener.

7. The backlight assembly as claimed in claim 6, wherein the at least one fastener is integrated with the base plate of the light guide plate.

8. The backlight assembly as claimed in claim 7, wherein the at least one fastener comprises a locating slot having an arc-shaped profile.

9. The backlight assembly as claimed in claim 8, wherein the at least one lamp is one lamp, said one lamp is generally L-shaped, the at least one fastener is one fastener, and a bent portion of said one lamp is fixed in the locating slot of said one fastener.

10. The backlight assembly as claimed in claim 9, further comprising a casing covering part or all of the bent portion of said one lamp, the casing being made of elastic material.

11. The backlight assembly as claimed in claim 7, wherein the base plate has a rectangular shape, the at least one fastener is two fasteners, and the fasteners are arranged at two adjacent comers of the base plate respectively.

12. The backlight assembly as claimed in claim 11, wherein the at least one lamp is one lamp, said one lamp is generally U-shaped, and two bent portions of said one lamp are fixed in the locating slots of the fasteners respectively.

13. The backlight assembly as claimed in claim 7, wherein the base plate has a hexagonal shape, the at least one fastener is three fasteners, and the fasteners are arranged at three non-adjacent corners of the base plate respectively.

14. The backlight assembly as claimed in claim 13, wherein the at least one lamp is three lamps, each lamp is generally V-shaped, and a bent portion of each lamp is fixed in the locating slot of a corresponding one of the fasteners respectively.
